(19) United States
(12) Patent Application Publication
(10) Pub. No.: US 2016/0376773 A1
(43) Pub. Date: Dec. 29, 2016

(54) Method for Automatic Water Leak Detection and Mitigation of Residential and Commercial Water Supply Systems

(71) Applicants: Zahi Said Abuhamdeh, Billerica, MA (US); Vincent D'Alessandro, Billerica, MA (US)

(72) Inventors: Zahi Said Abuhamdeh, Billerica, MA (US); Vincent D'Alessandro, Billerica, MA (US)

(73) Assignee: Silicon DFx, Inc., Billerica, MA (US)

(21) Appl. No.: 14/752,963

(22) Filed: Jun. 28, 2015

(51) Int. Cl. E03B 7/07; E03B 7/08; E03B 7/00; G01M 3/28

(52) U.S. Cl. CPC E03B 7/071; G01M 3/2807; E03B 7/075; E03B 7/08; E03B 7/003

(57) ABSTRACT

Water leakage or rupture related problems in plumbing systems are major causes of damage to homes and small offices. A single leak can easily destroy a significant portion of a home or office in minutes. Currently, there is no system that comprehensively covers the management of catastrophic water rupture failures for a house or office space. Current solutions involve water leak detection or simple water supply cutoff valves. There is no existent solution that actively reduces the risk of water damage when the house or office is not in use.

### SUMMARY OF EXAMPLE EMBODIMENTS

Considered broadly, three electronically controlled water valves according to the invention are used to drain a residential or commercial water supply system. The valves are controlled by wire to a single valve controller or to multiple valve controllers that are networked together wirelessly. The Valve Controller(s) can enable the valves to shut off the main water supply, open a drain path for the existing water to escape from, and open a venting valve for facilitating the drainage. The three valves are installed in such a way that they facilitate draining either by syphoning the water out of the system or by using gravity to force the water out of the system. Water leak sensors are also used to facilitate detection of failure events in the water system and as such trigger the Valve Controller(s) to initiate the water draining operation. A human interface Central Controller can also be used to allow system monitoring and control by the user either through direct contact with the controller via buttons or touch screen interface, or via a web served page to a computer or portable digital device.

### BRIEF DESCRIPTION OF THE DRAWINGS

FIG. 1 is a diagram of an overview of an example embodiment described herein.

FIG. 2 is a diagram of the water flow expected when draining the water using syphoning action.

FIG. 3 Shows the elevation diagram of the drain pipe location to facilitate the syphoning action.

FIG. 4 Depicts the various configurations for the Valve Controller and its attached hardware.

FIG. 5 Depicts the electrical design for the electrical water sensor design.

FIG. 6 Valve Controller Flow Diagram.

FIG. 7 An Example Embodiment of the System is depicted.

FIG. 8 An Example Embodiment of a Connected Multi Unit System.

### DETAILED DESCRIPTION OF EXAMPLE EMBODIMENT

The following detailed description of example embodiments refers to the accompanying drawings. The same reference numbers in different drawings may identify the same or similar elements.

A residence or commercial business usually has a municipality supplying water into the property. This water is distributed under pressure and is one of the major conveniences of modern living. However, the distribution system and the appliances in the home or business can fail and cause uncontrolled water to leak into the property. This water can cause significant damage that can be very costly to repair.

It is important to remedy this breakdown before the damage becomes significant. For example, if a water leak develops in a toilet, the water overflow can cause damage to the flooring, ceiling, and walls below it. Also, exposure to mold can make the space hazardous to human health. To be able to minimize the times when the water distribution system is pressurized and full of water is important to reducing the risk of failure. Embodiments described herein utilize an automatic water draining system that removes all or a significant portion of the water from the plumbing system(s). This solution can also include water leak detection and home automation systems that can provide status and allow user input to change the state of the water system.

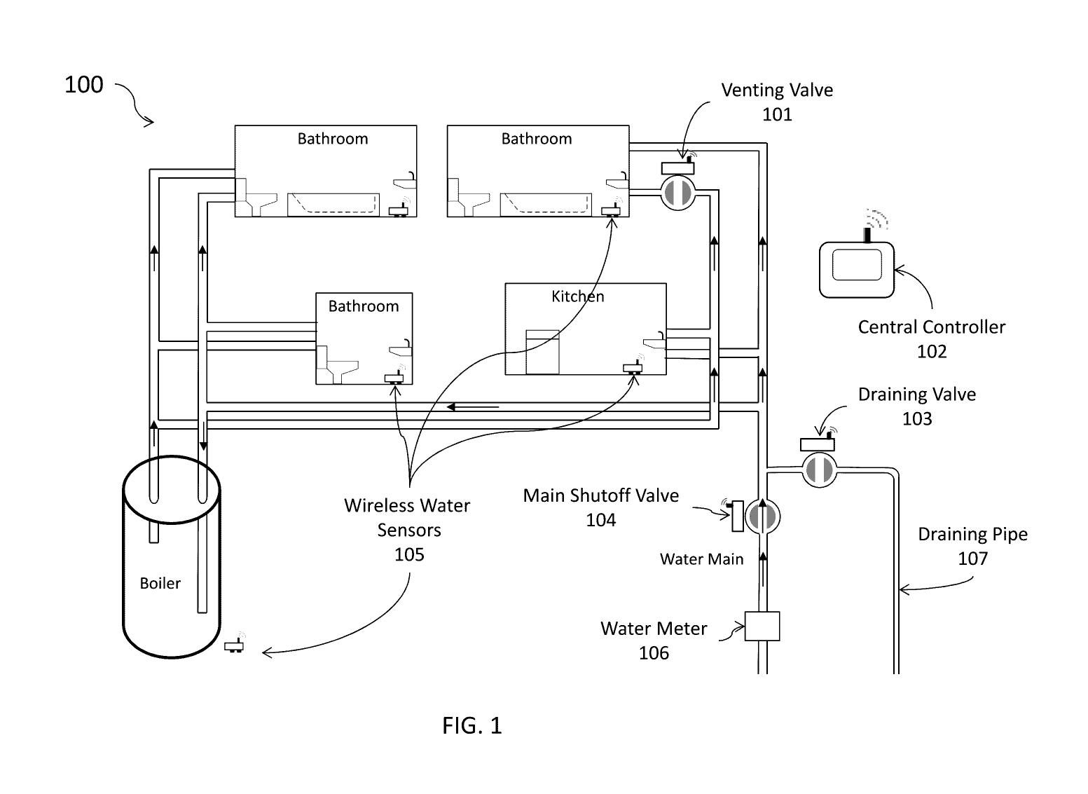

FIG. 1 is a diagram of an overview of an example embodiment 100 described herein. The main components of the system are: 1) A Main Shutoff Valve 104, 2) A Venting Valve 101 & 3) a Draining Valve 103. All three valves can be controlled to operate automatically through valve controllers. Remote battery operated Sensors 105 may be used to detect water leakage events. A Central Controller 102 that coordinates the remote sensors with the valve controllers may also be used.

The system is installed by first placing a Main Shutoff Valve 104 at the water inlet of the house in-line past the main water meter 106 and before the water reaches any of the end use points of any appliance or water dispensing devices such as faucets or toilets.

Second a Venting Valve 101 and a Drain Valve 103 are installed to empty out the water from the system. A Drain Valve is installed in such a way as to have its inlet be in line past the Main Shutoff Valve on the cold water distribution system including anywhere next to a major appliance such as a hot water heater tank where it is at the lowest point of where the water is distributed too.

A Venting Valve 101 is installed at the highest point in the water distribution system. Furthermore, this Venting Valve may be placed on the hot water pipes. This valve provides the air needed to push the water out of the water pipes.

When the system is in normal operation, the Main Shutoff is opened and the Drain and Venting Valves are closed. This operates similarly to any other water distribution system. When the system is to be shut off, the Main Shutoff Valve is closed simultaneously, as the Drain and Venting Valves are opened. This creates a flow of water from the top of the water pipe system to the lowest point of the water pipe system to a draining point.

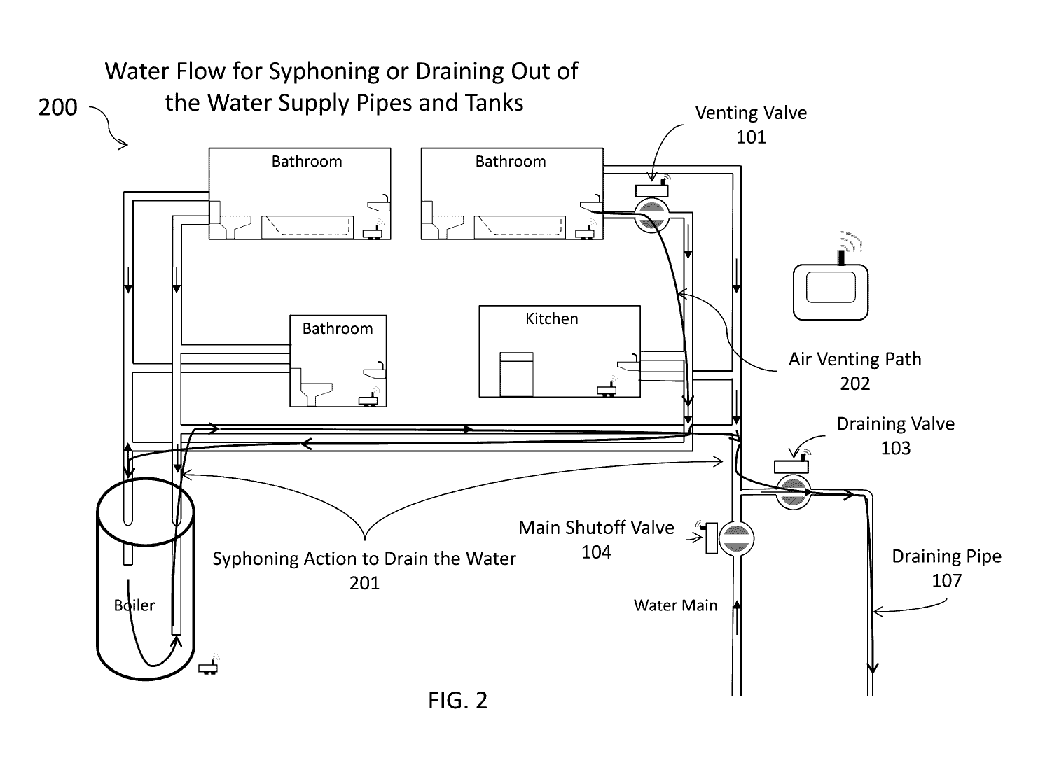

FIG. 2 depicts when all the three valves are configured as described above. A draining flow will start and a syphoning action 201 may occur and pulls the water from the lowest point of the pipe distribution system to the Drain Pipe outlet. In some embodiments, gravity fed draining might be the main method of draining the water from the system. For both draining methods, an Air Venting Path 202 will be necessary to facilitate the water movement out of the pipes and tanks in the water distribution system.

The Venting Valve 101 may be placed in such a way as to have one end connected to the hot water supply and the other end connected to a drain pipe such that when it is open and water is present, it can drain into the drain pipes already in existence in the system.

The three valves can be used to control the whole water system supply or be used to control sub-sections of the water supply within a unit. This will allow a part of the residence or office not in use to be shut down while other sections are fully functional.

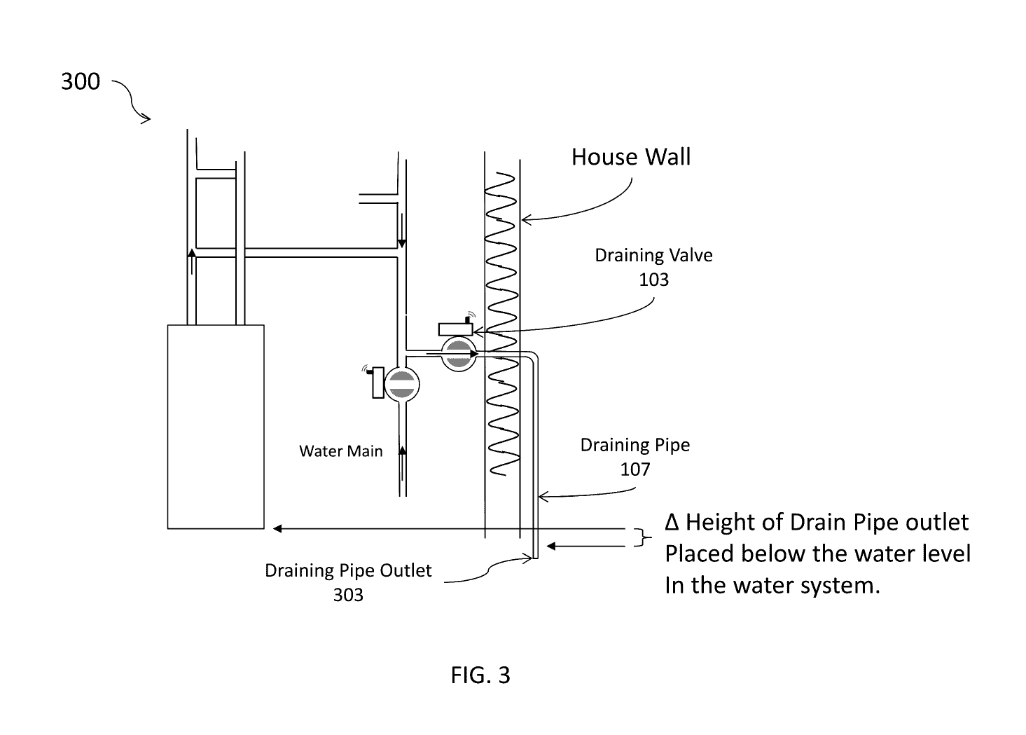

FIG. 3 depicts a possible embodiment of the Drain Valve 103 to maximize the potential for syphoning draining action. The Drain Pipe Outlet 303, can be placed below the lowest water level present in the water distribution system. For example, the hot water tank might be in the basement and represent the lowest level. A Drain Pipe Outlet can be placed below that base of the hot water tank and with the ensuing syphoning action, most of the water in the hot water tank can be drained. This along with all the other water in the system can be drained.

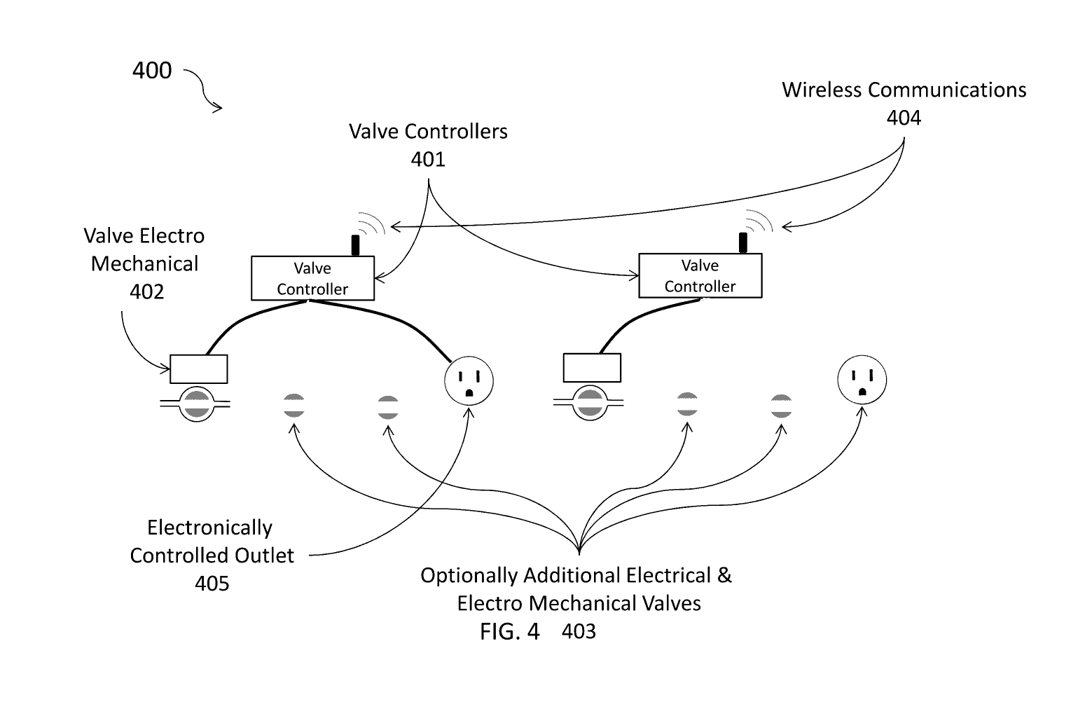

All three Valves can be controlled by a Valve Controller 401 that is depicted in FIG. 4. The Valve Controller drives an Electromechanical Valve 402 to the desired state by using internal electronics components. A single Valve Controller can be used to control all three valves: Main Shutoff, Vent, and Drain Valves 403. Optionally, multiple Valve Controllers 401 can be used to control the Electromechanical Valves. In such a case, wireless communication can be used to communicate between the Valve Controllers. The Valve Controllers will embed the necessary software procedures to facilitate having all the Valve Controllers operating together and performing the functions of opening and closing the valves similarly to what a single Valve Controller would.

The Valve Controller can also send the necessary electrical signaling to a switched power outlet that can allow control of an appliance that can be damaged if there is no water present in said appliance. An example such appliance is a hot water tank that cannot detect that there is no more water in it but keeps on heating. This process can result in damage. By turning off this appliance, the damage can be minimized.

Furthermore, a buzzer or an audible warning can be used signal an alarm condition when a water leak has been detected.

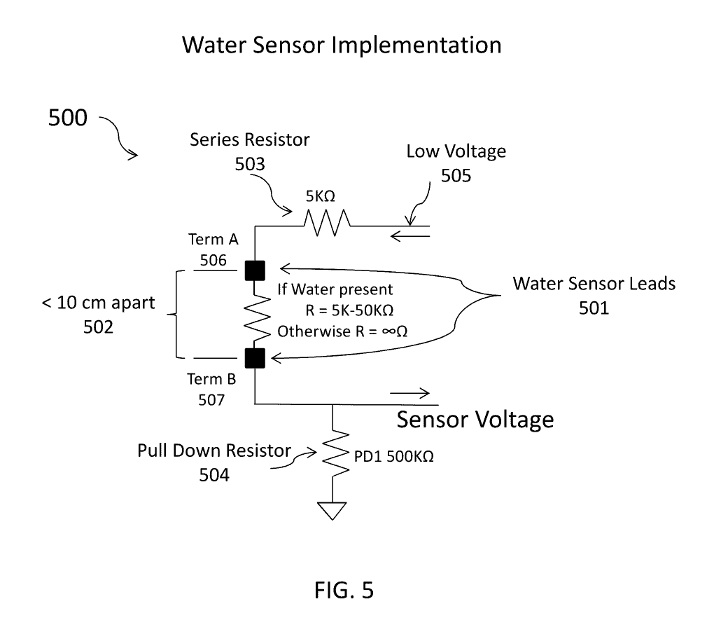

Depicted in FIG. 5, Water Detection Sensors may be used in this system to identify any leaks developed in the system. The water detection system can be built using a two wired terminal to detect the water resistance between the two terminals 501. The water is expected to have 5K-50K Ohm resistance. Term B 507 was built by Pulling it Down through a resistor 504 and sending this signal to a voltage sensor where we can measure it. By applying a low voltage 505 through a Series Resistor 503, which energizes Term A 506 of the water sensor. If there is water present, Term B 504 will overcome the pull down resistor and pull up Term B to almost the same voltage as what was applied on Term A 505. Below is a sample calculation of what we can expect based on applying a 3.3V to the Series Resistor 503:

| Water Present | Resistance Between Term A & B | Sensor Voltage |
|---|---|---|
| No | ∞ Ω | 0 Volts |
| Yes | 5 KΩ | 3.235 V |
| Yes | 50 KΩ | 2.973 V |

A water sensor can be built using wireless communications as well as be battery powered. Alternatively, a detection circuit can be added to the Valve Controller to perform the water sensing function.

Water sensors can also be based on floaters either mechanical or reed switch activated. As such, each sensor will float when enough water is present and either push a mechanical switch or activate a Reed Switch contact to create a short circuit. As such, the sensor can be connected to Term A and Term B and the desired system operation be achieved.

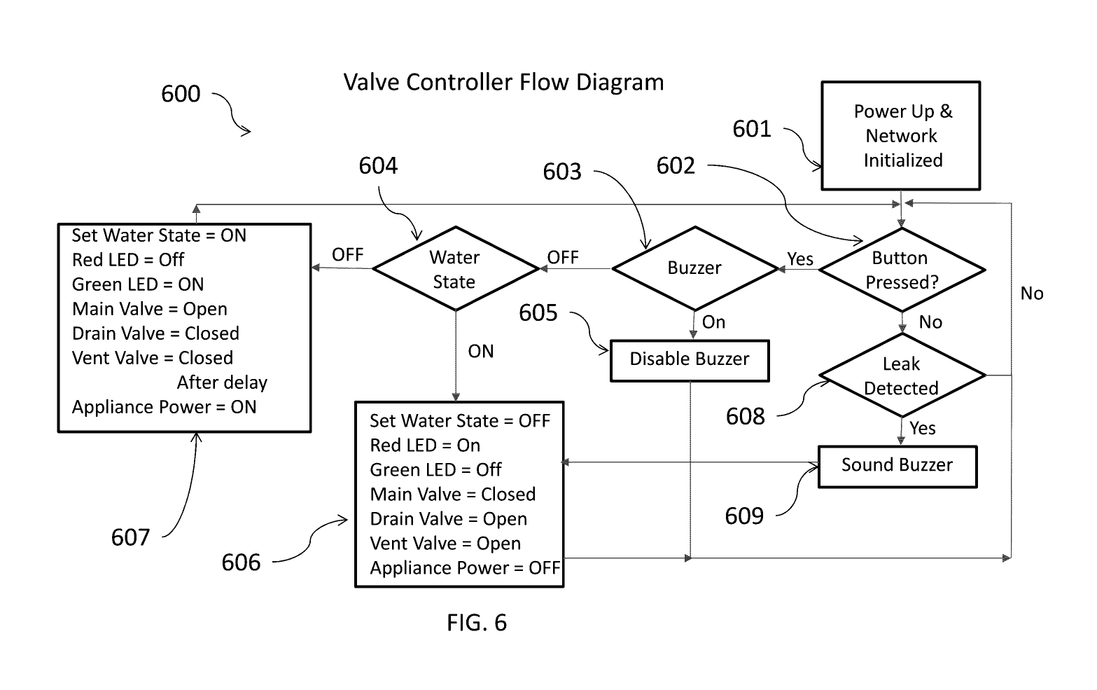

FIG. 6 shows the flow diagram for the water detection and mitigation system. The initial step 601 is entered when the controller is powered up. A system is built using one or more controllers. The same data and state is broadcast to all the controllers and each are expected to be synchronized to each other with their response and when they step through their states to a few 10s of milliseconds. As such, we can describe a global operation model that applies to all the controllers. The controllers establish their communications with each other and get initialized to a common state within the system. Then the controllers monitor for any activity through either a button getting pressed 602 or a leak being detected 603 from any controller or water sensor. If a button is pressed 602, and if the buzzer is on 603, then this single button press will turn it off 605 and control goes back to monitoring the system in 602. If a button is pressed 602 and the buzzer is not on, then the next check is whether the water state is ON or OFF 604. If the water is ON, then the water state will be turned off 606. This translates to switch LED lights to indicate the state of the water supply as well as controlling the valves into the desired state to turn off the water supply and drain the water from the system. Any appliance controls will also be updated in this state to either ON or OFF. If we enter state 604 and the water is OFF, then we will turn the water system state to ON with its associated LEDs, valves and appliance settings in 607.

If a water leak is detected in state 608, then the buzzer or an audio alarm will sound 609 and we immediately go to state 606 to turn off the water and drain it from the system.

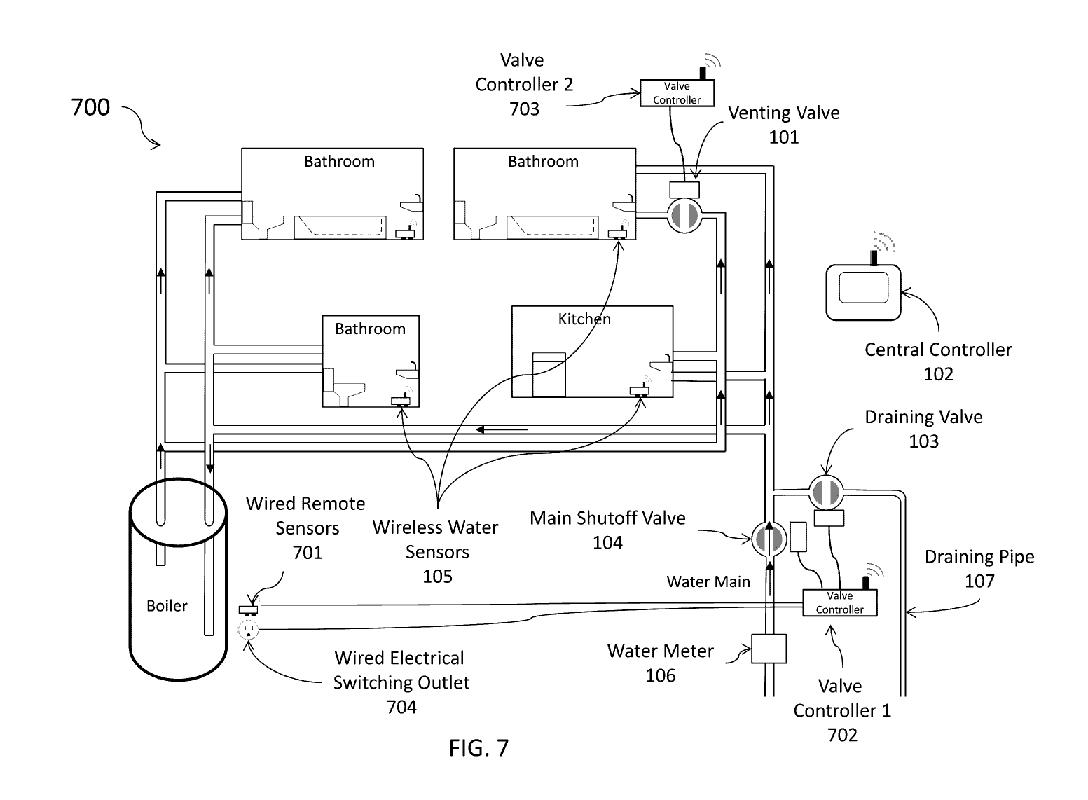

Preferred Embodiment of this system is depicted in FIG. 7. Two Valve Controllers 702 and 703 are used to control all three Valves 104, 103 & 101. The Valve Controller 1 702, will control the Main Shutoff Valve 104 and the Drain Valve 103. It will also be connected to a wired water sensor for detecting any water leakage. A second Valve Controller 703, will control the Venting Valve. This combination of which valve the Valve Controller controls can be adjusted based on the location and the physical dimensions of the installation. For instance, one Valve Controller can drive all three valves or three Valve Controllers can drive one valve each. Therefore, any combination of Valve Controllers and Valves can be supported.

Wireless Water Sensors 105 and Wired Remote Water Sensors 701 can be placed at different locations based on where the water leakage risk is higher, as the case maybe with an appliance such as a washer or a toilet. The Wireless Water Sensors will be battery powered and can be easily placed anywhere required.

An optional electronically controlled switching power outlet 704, can be added to the system to allow powering down of any appliance that might be damaged by the lack of water being present in the system.

The Valve Controllers and the Wireless Water Sensors will all be networked together to the Central Controller such that each component is monitored or maintained to optimal level based on the end user. The Valve Controllers state of their valves and the expected flow of water will be constantly maintained by the Central Controller. The Wireless Water Sensors will be monitored for good wireless communication signal strength and for healthy battery life values. For instance, if the battery charge is low, the Central Controller will notify that status for maintenance work to fix the problem.

The Central Controller will also maintain a human interface capability through a display screen. The Central Controller also acts as an HTML server for local area network devices, Wi-Fi devices or through an external server to make its status available to interfaces like smart phones, computers, or wireless devices weather inside or outside of the home or office. Any of the above combination can be used to best match the user's preference and represent the system status.

A user might want to optionally request certain operations of the system. For instance, request to have the water shut off while the facility is not being used. This can be handled through the user interface with the Central Controller.

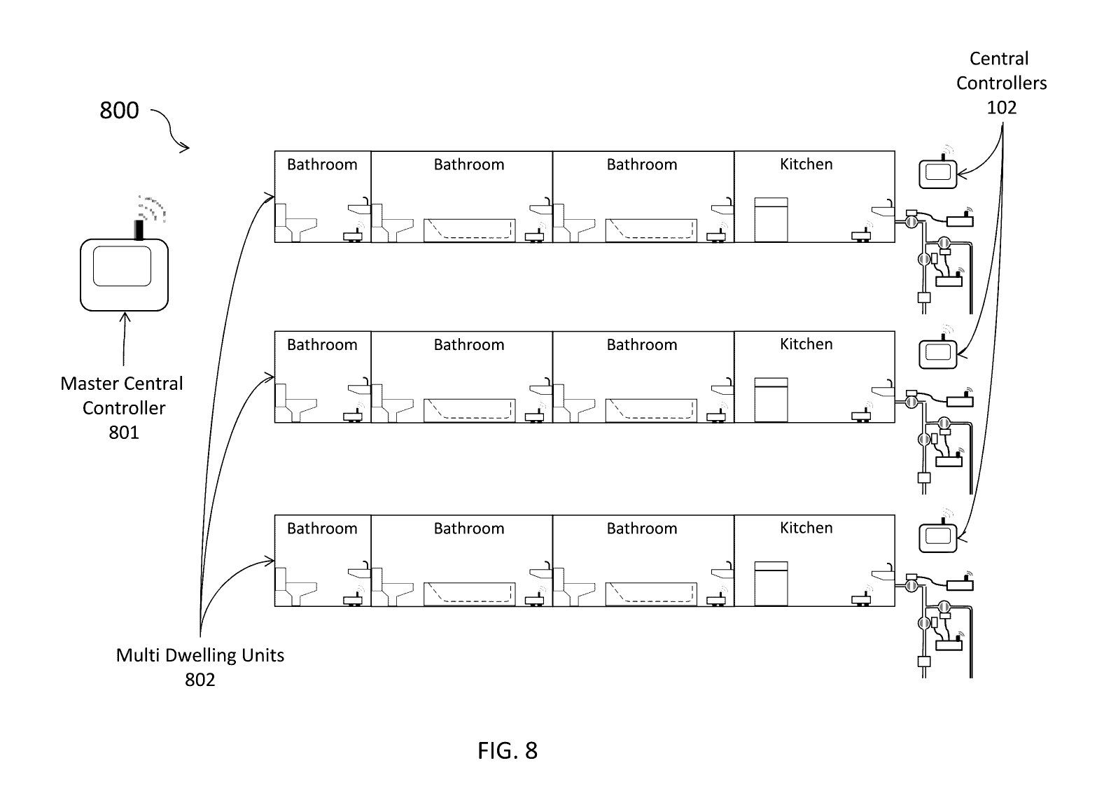

Multiple systems might also be deployed in a multiunit arrangement. FIG. 8 depicts an example of such an arrangement. Multiple units 802 comprised of apartments, condos or offices in the same general physical location can each have a system installed in them. As such, there might be a Central Controller 102 for each unit or zone, and each unit communicates to a Master Central Controller 801 that monitors their status and operation. The Master Controller's 801 main function is to be able to access and control each individual unit's Central Controller 102 with in this group of networked systems. As such, it can monitor all the Central Controllers in this group and get the status of the water system operation or be notified if there are any leaks detected locally by the system deployed in the units. Furthermore, this Master Central Controller 801 can call out a specific unit, sub units, or all units in the networked group and change their system operation. This Master Central Controller 801 is expected to be operated by the maintenance or supervisory teams for such a multiunit group.

This Master Central Controller 801 provides a human interface either through its own display screen or by serving its own HTML code to a digital device such as a tablet or PC. Additionally, this Master Controller can communicate through a specialized and secure server to the portable devices through the internet and provide a remote control mechanism for all the connected Central Controllers 102 with in its domain.

1. Water draining system comprising of the following controller or controllers and three electromechanical valve components to achieve a complete or partial draining of the water existing in the plumbing system using either syphoning fed or gravity fed draining:
a. An electronically actuated mechanical valve that can shut off the main water supply, along with an electronically actuated mechanical valve that can drain the existing water in the residence or property along with an electronically actuated mechanical valve that can vent the water pipes in the residence or property to facilitate the draining action.
b. A Valve Controller that can control all three valves or any combination of wherein. In the case of using two or more Valve Controllers, a wireless or wired communications system may be used to facilitate the communications between the controllers to coordinate the valve actuations to achieve the same behavior of the Valves as a single controller would provide.
c. A Valve Controller that can optionally provide the signaling to an electronically controlled electrical switching supply system that can selectively turn off or on appliances that can be damaged by the lack of water in them.
d. A Valve Controller that can optionally provide the water sensing terminals A and B described in the Detailed Description section above, for the detection of the presence of water.

2. System for water leak detection and user water management functions from any combination of the following but not necessarily all of them, along with the above water draining system:
a. A Central Control system that performs the following, but not limited to all or any combination of wherein for the user:
i. Provides Water Leak Status of the system to the user.
ii. Maintains system operational integrity for good networking and battery maintenance status.
iii. Displays and Controls water supply and draining activities in the water supply based on user input.
b. Monitors for water sensors that are wired, wireless, wall powered, or battery powered connected to a Valve Controller or Central Controller or any combination wherein and includes all electronic or electromechanical methods used to detect the presence of water.
c. Valve controllers that control shutting off the main water inlet. A drain valve and a venting valve for removing water from the water supply system. Valve controller is interconnected to others wirelessly or can single handedly control the whole or a part of the water supply system.

3. A Multiunit System comprised of the following or any combination of wherein in a multiunit apartment, condo or office structure or complex:
a. A Single Unit of a system installation described above comprising of the following:
i. The Valve Control system.
ii. Optional water leak sensors.
iii. Optional central controller for providing a local human interface within a single unit.
b. A Master Central Controller that monitors and controls the operation of a group of Central Controllers or Valve Controllers in a single unit for monitoring and managing the operation of an individual, sub-group, or full group of units in the group.
